(19) United States
(12) Patent Application Publication
(10) Pub. No.: US 2004/0146250 A1
(43) Pub. Date: Jul. 29, 2004

(54) Ferrule and optical coupling structure using the same

(75) Inventors: Tomohiro Wakabayashi, Susono-shi (JP); Hiroki Kawai, Susono-shi (JP); Saori Saito, Susono-shi (JP); Kazuharu Tsuchiya, Susono-shi (JP)

Correspondence Address: SUGHRUE MION, PLLC, 2100 PENNSYLVANIA AVENUE, N.W., SUITE 800, WASHINGTON, DC, 20037, US

(73) Assignee: YAZAKI CORPORATION

(21) Appl. No.: 10/705,233

(22) Filed: Nov. 12, 2003

(30) Foreign Application Priority Data
Nov. 11, 2002 (JP) P2002-327177
Aug. 22, 2003 (JP) P2003-298236

(51) Int. Cl. G02B 6/36

(52) U.S. Cl. 385/79

(57) ABSTRACT

A ferrule is attached to a terminal of an optical fiber. The ferrule is provided with a main body, and a leading end portion integrated with the main body to serve as a convex lens such that light emitted from a core wire of the optical fiber is made to be parallel light, while incident light is focused onto the core wire.

### BACKGROUND OF THE INVENTION

The present invention relates to a ferrule attached to a terminal of an optical fiber. The present invention also relates to an optical coupling structure in which a pair of such ferrules are opposed to each other.

In recent years, optical communication at inside of an automobile has spread and a communication capacity thereof has increased. Under such a situation, an optical fiber used in recent optical communication has a small core diameter and large transmission band. With regard to connection of optical fibers in an automobile, in view of the influence of vibrations or impacts, leading ends of core wires of optical fibers cannot be brought into contact with each other. Accordingly, there is proposed an optical coupling structure in which two optical fibers are optically coupled by at least one lens disposed between ferrules which are provided with the respective terminals of the optical fibers (disclosed in Japanese Patent Publication No. 8-271758A, for example).

Briefly explaining the above-described optical coupling structure with reference to FIG. 6, respective terminals of a pair of optical fibers 1a, 1b to be coupled are attached with ferrules 2a, 2b. Further, flanges 3a, 3b are fitted on respective outer peripheral faces of the ferrules 2a, 2b. At one ends of hollow portions in cylindrical lens holder 4a, 4b, lenses 5a, 5b are respectively held. At the other ends of the hollow portions, one end portions of the ferrules 2a, 2b are respectively inserted.

Centers of end faces of the ferrules 2a, 2b opposed to each other are arranged with end faces of the optical fibers 1a, 1b, optical axes of the optical fibers 1a, 1b and optical axes of the lenses 5a, 5b are aligned with each other. End faces of the flanges 3a, 3b and end faces of the lens holders 4a, 4b are bonded to fix by welding or the like. Further, respective outer peripheral faces of the lens holders 4a, 4b are fitted into a cylindrical sleeve 6 in a state where the end faces of the lens holders 4a, 4b at which the lenses 5a, 5b are held are opposed to each other.

In the above-described constitution, the two lenses 5a, 5b are, arranged between the end faces of the ferrules 2a, 2b to thereby achieve a reduction in connection loss by axial deviation.

Meanwhile, in connecting the optical fibers 1a, 1b in the above-described optical coupling structure, a problem that a number of parts is large is posed. Further, there poses a problem that a number of steps until connecting the optical fibers 1a, 1b is large and productivity is poor. With regard to productivity and connection loss by axial deviation, there also poses a problem that high working accuracy is required for all of the lens, the lens holder, the flange and the ferrule owing to the structure in which the lenses 5a, 5b are aligned by the lens holders 4a, 4b, and the cylindrical sleeve 6 and the ferrules 2a, 2b are aligned by the flanges 3a, 3b and the lens holders 4a, 4b.

### SUMMARY OF THE INVENTION

It is therefore an object of the invention to provide a ferrule and an optical coupling structure capable of achieving a reduction in a number of parts, promotion of productivity and a reduction in connection loss.

In order to achieve the above object, according to the invention, there is provided a ferrule attached to a terminal of an optical fiber, the ferrule comprising:

a main body; and

a leading end portion, integrated with the main body to serve as a convex lens such that light emitted from a core wire of the optical fiber is made to be parallel light, while incident light is focused onto the core wire.

In such a configuration, since the convex lens is integrated with the ferrule, it is not necessary to provide the conventional lens holder or the member for aligning the optical axes of the lenses and ferrules. Further, it is possible to simplify the process to establish the optical connection between the optical fibers. Still further, it is possible to reduce the number of parts which require the dimensional accuracy.

Preferably, at least the leading end portion is comprised of optically transparent resin. In accordance with the required productivity or cost, the ferrule may be entirely molded with the above resin.

Preferably, the main body is formed with a hole into which the core wire is inserted such that a clearance is formed between a deepest portion of the hole and a leading end of the core wire. Here, the clearance is filled with filler such that the clearance serves as a light guide path.

In such a configuration, since the clearance is provided between the leading end of the core wire and the deepest portion of the hole, the dimensional accuracy for the optical fiber and the ferrule is not required, so that the productivity can be promoted. Further, since the clearance is filled with the optically transparent filler, the connection loss can be reduced.

Here, it is preferable that the filler is comprised of adhesive for fixing the optical fiber in the hole.

In such a configuration, since the filler also serves as adhesive, the fixation of the optical fiber can be completed at the same time. Thus, the productivity can be further promoted. UV-curing adhesive may be adopted as the adhesive.

It is further preferable that a refractive index of the adhesive is selected so as to be greater than a refractive index of a material forming the leading end portion, and so as to have a refractive index difference corresponding to a numerical aperture of the core wire. In this case, the light guide function of the filler can be secured.

Alternatively, it is preferable that the filler is comprised of an optically transparent gel. Silicone resin may be adopted as the gel.

The transparent gel is advantageous to prevent cracks or clearances produced by a temperature change or in curing the filler when the filler is solidified. Further, the transparent gel is advantageous to restrain fluidity, whereas when a liquid is used as a filler, sealing is difficult to achieve.

It is further preferable that a refractive index of the gel is selected so as to be greater than a refractive index of a material forming the leading end portion, and so as to have a refractive index difference corresponding to a numerical aperture of the core wire. In this case, the light guide function of the filler can be secured.

According to the invention, there is also provided an optical coupling structure, comprising a coupler, formed with a hollow portion in which leading end portions of the above ferrules are opposed to each other.

Since the ferrules are integrally provided with the lenses, the number of parts can be reduced. Further, high dimensional accuracy for the alignment is not required, thus promoting the productivity.

According to the invention, there is also provided a ferrule attached to a terminal of an optical fiber, the ferrule comprising:

a main body; and

a convex lens, integrated with a leading end of the main body such that light emitted from a core wire of the optical fiber is made to be parallel light, while incident light is focused onto the core wire.

According to the invention, there is also provided an optical coupling structure, comprising a coupler, formed with a hollow portion in which leading end portions of the above ferrules are opposed to each other.

### BRIEF DESCRIPTION OF THE DRAWINGS

The above objects and advantages of the present invention will become more apparent by describing in detail preferred exemplary embodiments thereof with reference to the accompanying drawings, wherein:

FIG. 1 is a sectional view showing a ferrule according to a first embodiment of the invention;

FIG. 2 is a perspective view showing the ferrule of FIG. 1;

FIG. 3 is a sectional view showing an optical coupling structure using the ferrule of FIG. 1;

FIG. 4 is a graph showing a misalignment characteristics of the ferrule of FIG. 1;

FIG. 5 is a sectional view showing a ferrule according to a second embodiment of the invention; and

FIG. 6 is a sectional view showing a related-art optical coupling structure.

### DETAILED DESCRIPTION OF THE INVENTION

Preferred embodiments of the invention will be described below in detail with respect to the accompanying drawings.

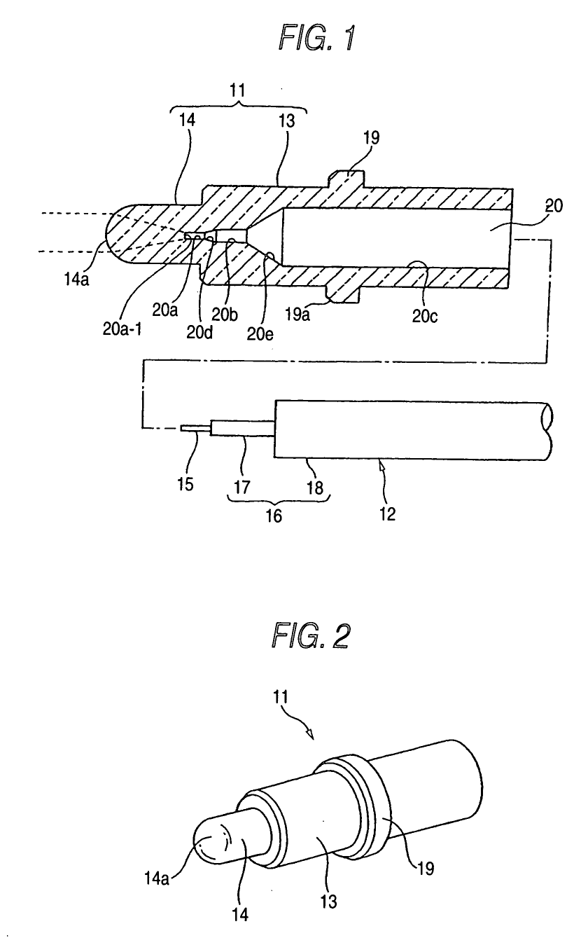

FIGS. 1 and 2 show a ferrule 11 according to a first embodiment of the invention. The ferrule 11 is attached to a terminal of an optical fiber 12. In this embodiment, the ferrule 11 is entirely molded with transparent synthetic resin so as to comprise a cylindrical main body 13 and a bullet-shaped leading end portion 14.

Here, as the transparent synthetic resin material, acrylic resin, alicyclic olefin resin, alicyclic acrylic resin or the like is pointed out although not particularly limited. The synthetic resin materials are products on sale which are easy to obtain, and contributing to a reduction in cost.

An explanation will be given of a constitution of the optical fiber 12. The optical fiber 12 comprises a core wire 15 and a sheath 16. The sheath 16 is peeled at a predetermined position on a terminal side thereof. That is, the terminal of the optical fiber 12 is worked to expose the core wire 15 by a predetermined length. A leading end face of the core wire 15 is formed in a flat face.

The core wire 15 comprises a core, and a clad having a refractive index smaller than that of the core. In the embodiment, the core is molded by, for example, transparent polycarbonate (PC) although not particularly limited. Further, the clad is molded by transparent polymethyl metacrylate (PMMA). Further, the core wire 15 may be a known core wire made of glass.

The sheath 16 is made of a synthetic resin and is provided for protecting the core wire 15. In the embodiment, the sheath 16 comprises a primary sheath 17 formed on the core wire 15 and a secondary sheath 18 formed on the primary sheath 17. Further, the secondary sheath 18 is peeled to expose the primary sheath 17 by a predetermined length.

An optical axis of the main body 13 and an optical axis of the leading end portion 14 are aligned with each other. An outer peripheral face (side face) of the main body 13 is formed with a flange 19. An inner portion of the ferrule main body 13 is formed with a ferrule hole 20 which is opened at a rear end of the ferrule 11.

The flange 19 is formed at a middle of the outer peripheral face. A taper 19a having a pertinent angle is peripherally provided at a front end of the flange 19. The ferrule hole 20 is formed such that a center axis thereof coincides with the optical axis and includes a core wire guide portion 20a, a primary sheath guide portion 20b and a secondary sheath guide portion 20c successively from the leading end. The ferrule hole 20 is filled with a filler (not illustrated), mentioned later.

The core wire guide portion 20a is a portion inserted with the core wire 15 and is formed in a shape having a diameter as same as that of the core wire 15. Further, the core wire guide portion 20a is formed to produce a clearance between a deepest portion 20a-1 thereof and a leading end of the core wire 15. The depest portion 20a-1 of the core wire guide portion 20a is worked by surface roughness to be able to restrain to reduce scattering of light. The core wire guide portion 20a is extended to a position of spanning the leading end portion 14. However, the core wire guide portion 20a is not limited to this configuration.

The primary sheath guide portion 20b is a portion for inserting the primary sheath 17 and formed in a shape having a diameter as same as that of the primary sheath 17. The secondary sheath guide portion 20c is a portion for inserting the secondary sheath 18 and is formed in a shape having a diameter as same as that of the secondary sheath 18. Tapered portions 20d is formed between the core wire guide portion 20a and the primary sheath guide portion 20b owing to differences in diameters. Tapered portion 20e is formed between the primary sheath guide portion 20b and the secondary sheath guide portion 20c owing to differences in diameters. The tapered portions 20d and 20e are set to pertinent angles. The optical fiber 12 is made to be easy to insert by forming the tapered portions 20d and 20e.

In the embodiment, as the filler, an adhesive cured by irradiating ultraviolet ray and made to be optically transparent is used. The filler is filled in a range, for example, from the deepest portion 20a-1 of the core wire guide portion 20a to the tapered portion 20e. When the optical fiber 12 is inserted into the ferrule hole 20so that the clearance between the deepest portion 20a-1 and the front end of the core wire 15 is filled by the filler, and the optical fiber 12 is adhered to fix thereby. When the core wire 15 is fixed in such a way, there is achieved an advantage of capable of preventing pistoning (movement of the core wire 15 in its axial direction) due the temperature or humidity change.

The refractive index of the filler is larger than the refractive index of the ferrule material (the above-described synthetic resin material) and is selected to provide a difference between refractive indices in correspondence with a numerical aperture (N.A) of the core wire 15. The numerical aperture is defined by N.A.=sin θₘₐₓ. Here, θₘₐₓ represents a maximum light receiving angle. Light is reflected by a wall face of the clearance in the ferrule hole 20 and the clearance portion serves as a light guide. There is also achieved an advantage of facilitating to design the lens.

The leading end portion 14 of the ferrule 11 serves as a convex lens. That is, the leading end portion 14 is integrally formed with a convex lens 14a. In the embodiment, the convex lens 14a is worked in a spherical shape, which is formed in a shape such that light emitted from the core wire 15 is made to be parallel light, while parallel incident light is focused to the core wire 15. The dashed line in FIG. 1 indicates an optical path. Such a convex lens 14a is designed while considering a distance from the deepest portion 20a-1 of the core wire guide portion 20a.

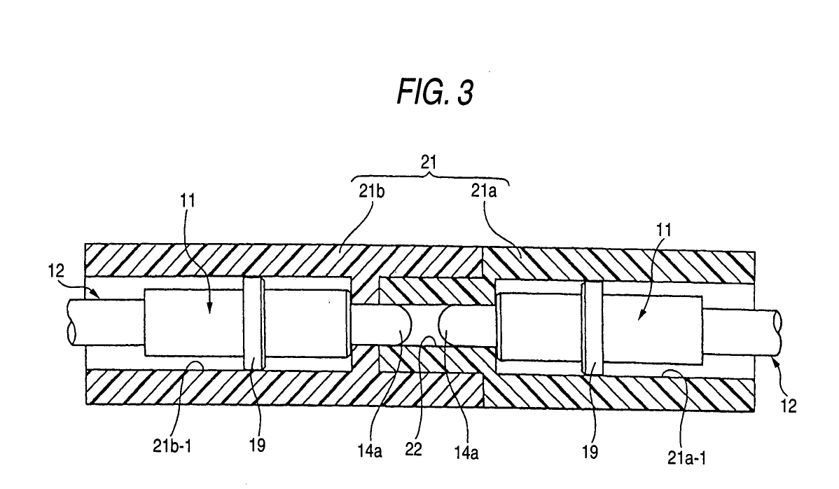

Upon attaching the ferrule 11 to the terminal of the optical fiber 12, the ferrule hole 20 is first filled with the filler (not shown). Then the optical fiber 12 is inserted into the ferrule hole 20, and ultraviolet ray is irradiated to cure the filler. In order to establish a connection between optical fibers 12, a pair of thus obtained ferrules 11 are opposed to each other within a hollow portion 22 of a coupler 21 as shown in FIG. 3.

In the embodiment, the coupler 21 comprises a male housing 21a and a female housing 21b so as to establish the fitting relationship as shown in FIG. 3. However, the coupler 21 is not limited to this structure so long as the ferrules 11 are able to be opposed to each other while aligning the optical axes thereof. Notations 21a-1 and 21b-1 designate guide portions for guiding the main bodies 13 of the ferrules 11. A portion for aligning the optical axes of the ferrules 11 may be any of the hollow portion 22 or the guide portions 21a-1 and 21b-1.

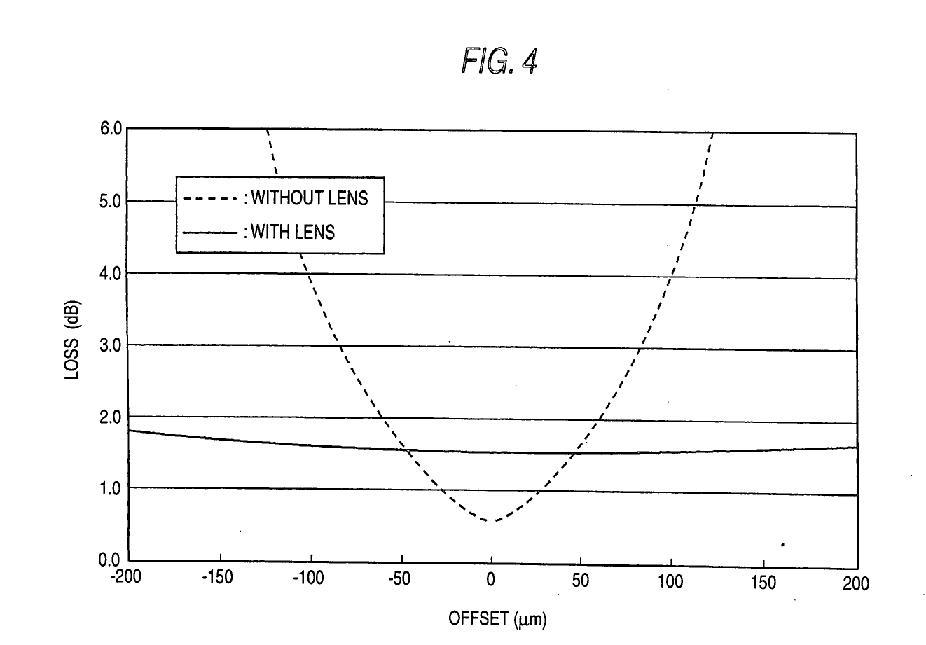

An explanation will be given here of an effect of the lens of the ferrule 11 with reference to FIG. 4 showing the misalignment characteristics. The data was obtained by the following way. An optical fiber having a core diameter of 200 μm was used and the ferrule 11 was fabricated by a dimension suitable thereto. The thus fabricated ferrules 11 are opposed to each other as shown in FIG. 3. In this graph, the solid line represents the misalignment characteristics of the ferrule 11 according to this embodiment. The dashed line represents the misalignment characteristics of a related-art ferrule which is not provided with the convex lens 14a.

As shown in FIG. 4, since the emitted light from the core wire 15 is made to be parallel light by the convex lens 14a, the misalignment loss is reduced, and the connection loss is made less than that in the related-art ferrule in a case where the misalignment is 50 μm or more. Adopting the relatively inexpensive resin molding, it is difficult to work the ferrule by the misalignment less than 50 μm. Actually, the misalignment more than 50 μm is brought about. Therefore, it is apparent the use of the ferrule 11 according to this embodiment is advantageous.

According to the embodiment, since the convex lens 14a is integrated with the ferrule 11, it is not necessary to provide the conventional lens holder or the member for aligning the optical axes of the lenses and ferrules. Further, it is possible to simplify the process to establish th optical connection between th optical fibers 12. Still further, it is possible to reduce the number of parts which require the dimensional accuracy.

In addition, since the clearance is provided between the leading end of the core wire 15 and the deepest portion 20a-1 of the ferrule hole 20, the dimensional accuracy for the optical fiber and the ferrule is not required, so that the productivity can be promoted. Further, since the clearance is filled with the optically transparent filler, the connection loss can be reduced. Still further, since the filler also serves as adhesive, the fixation of the optical fiber can be completed at the same time. Since the refractive index of the filler (adhesive), the light guide function thereof can be secured.

As the filler, in place of the UV cured adhesive, a thermosetting transparent gel and a fixing adhesive may be used. A transparent gel having a known refractive index when it is cured is applicable. Specifically, it is larger than the refractive index of the ferrule material and provides a difference in the refractive indices in correspondence with the light receiving angle of the core wire 15. For example, a portion extended from the core wire guide portion 20a to the tapered portion 20e is filled with double component type silicone resin. The transparent gel is advantageous to prevent cracks or clearances produced by a temperature change or in curing the filler when the filler is solidified. Further, the transparent gel is advantageous to restrain fluidity, whereas when a liquid is used as a filler, sealing is difficult to achieve.

Meanwhile, the fixing adhesive is flown into the ferrule hole 20 to fill the secondary sheath guide portion 20c. The fixing adhesive has a viscosity of not excessively invading the inner portion. Specifically, there are an epoxy species adhesive, an epoxy mixture species and the like. The transparent gel and the fixing adhesive in this case are thermally cured by a heating oven.

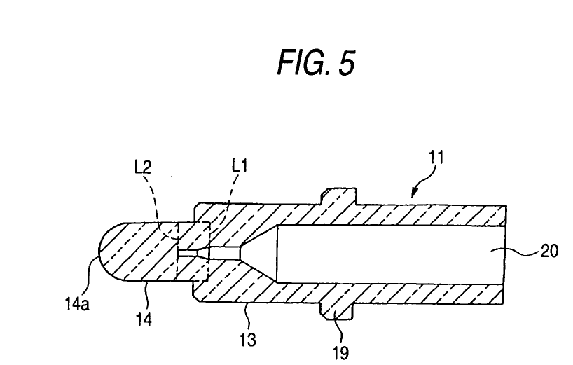

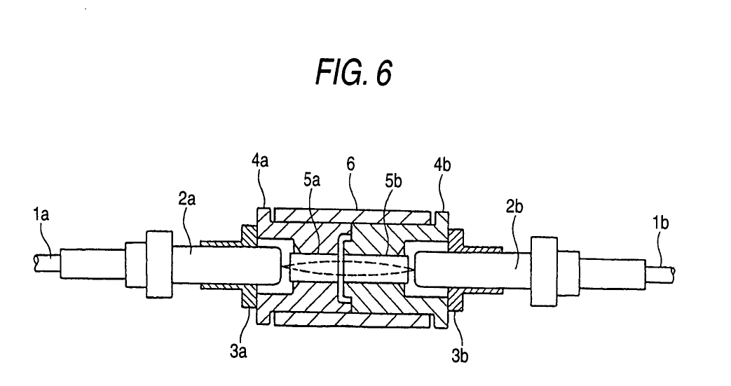

FIG. 5 shows a second embodiment of the invention. In this embodiment, the ferrule 11 may be divided at the line L1 or the line L2 to be assembled later, in accordance with the required productivity or cost.

In the above embodiments, only the leading end portion 14 may be molded by a transparent synthetic resin material, and the main body 13 may be molded separately by an inexpensive synthetic resin material.

The invention can naturally be modified within the change of not changing the gist of the invention. Further, the invention is not limited to connection of the optical fibers in the automobiles. That is, the invention is naturally applicable also to optical communication in other field.

What is claimed is:

1. A ferrule attached to a terminal of an optical fiber, the ferrule comprising:
a main body; and
a leading end portion, integrated with the main body to serve as a convex lens such that light emitted from a core wire of the optical fiber is made to be parallel light, while incident light is focused onto the core wire.

2. A ferrule attached to a terminal of an optical fiber, the ferrule comprising:
a main body; and
a convex lens, integrated with a leading end of the main body such that light emitted from a core wire of the optical fiber is made to be parallel light, while incident light is focused onto the core wire.

3. The ferrule as set forth in claim 1, wherein at least the leading end portion is comprised of optically transparent resin.

4. The ferrule as set forth in claim 1, wherein:
the main body is formed with a hole into which the core wire is inserted such that a clearance is formed between a deepest portion of the hole and a leading end of the core wire; and
the clearance is filled with filler such that the clearance serves as a light guide path.

5. The ferrule as set forth in claim 4, wherein the filler is comprised of adhesive for fixing the optical fiber in the hole.

6. The ferrule as set forth in claim 5, wherein a refractive index of the adhesive is selected so as to be greater than a refractive index of a material forming the leading end portion, and so as to have a refractive index difference corresponding to a numerical aperture of the core wire.

7. The ferrule as set forth in claim 4, wherein the filler is comprised of an optically transparent gel.

8. The ferrule as set forth in claim 7, wherein a refractive index of the gel is selected so as to be greater than a refractive index of a material forming the leading end portion, and so as to have a refractive index difference corresponding to a numerical aperture of the core wire.

9. An optical coupling structure, comprising:
a coupler, formed with a hollow portion in which leading end portions of ferrules each set forth in claim 1 are opposed to each other.

10. An optical coupling structure, comprising:
a coupler, formed with a hollow portion in which leading end portions of ferrules each set forth in claim 2 are opposed to each other.
